(19) United States
(12) Patent Application Publication
(10) Pub. No.: US 2025/0100334 A1
(43) Pub. Date: Mar. 27, 2025

(54) VEHICLE BUMPER AND TOWING/TUGGING ATTACHMENT

(71) Applicant: Howe & Howe Inc., Waterboro, ME (US)

(72) Inventors: Timothy Merlin Foley, Lyman, ME (US); Ronald Louis Lemons, Richmond, ME (US); Michael J. Zagorianakos, Buxton, ME (US)

(21) Appl. No.: 18/891,695

(22) Filed: Sep. 20, 2024

Related U.S. Application Data
(60) Provisional application No. 63/539,666, filed on Sep. 21, 2023.

(51) Int. Cl. B60D 1/56; B60D 1/02; B60R 19/04; B60R 19/24

(52) U.S. Cl. CPC B60D 1/56; B60D 1/02; B60R 19/04; B60R 2019/247

(57) ABSTRACT

A vehicle bumper that also serves as a towing and/or tugging receiver includes a U-shaped member having first and second ends and a midpoint therebetween. The first and second ends provide respective upper attachment points for attaching the bumper to the vehicle. The bumper further includes a triangular brace having first and second vertices that provide respective lower attachment points for further attaching the bumper to the vehicle, and a third vertex joined with the midpoint of the U-shaped member. A towing receiver is joined with the triangular brace for towing a wide range of payloads.

CROSS-REFERENCE TO RELATED APPLICATIONS: This application claims the benefit of copending U.S. Provisional Application No. 63/539,666, filed Sep. 21, 2023, the contents and teachings of which are incorporated herein by reference in their entirety.

### BACKGROUND

### 1. Field

This disclosure relates generally to vehicle designs, and more particularly to a bumper and towing/tugging attachment for a vehicle.

### 2. Description of Related Art

Firefighting robots are specially adapted vehicles for spraying water on fires. Smaller than firetrucks, firefighting robots are maneuverable and able to aim water accurately at desired targets. An example of a firefighting robot is the Thermite robot available from Howe & Howe, Inc. of Waterboro, ME. The Thermite is a remote controlled, tracked vehicle with a remotely aimed nozzle (monitor) that can discharge 1,500 gallons or more of water per minute. The Thermite has the ability to withstand environments that are too hazardous for human personnel.

Firefighting robots and other vehicles are often kept in large facilities, such as airports, police facilities, firefighting facilities, and military bases. In such locations, the firefighting vehicles remain available and ready to be deployed in the event of a fire.

### SUMMARY

Although firefighting vehicles are useful at fighting fires, the fires that necessitate such vehicles are infrequent events. It has been observed, though, that firefighting vehicles can serve a number of useful purposes even when they are not engaged in firefighting activities. For example, firefighting robots are adept at towing heavy objects, such as hoses and trailers. At many facilities, it would also be useful to provide towing capabilities for small airplanes and helicopters. What is needed, therefore, is a flexible towing solution that can extend the usability of firefighting robots and other vehicles to other requirements that normally arise at customer sites.

To address the above need at least in part, an improved technique provides a vehicle bumper that also serves as a towing and/or tugging receiver. The bumper includes a U-shaped member having first and second ends and a midpoint therebetween. The first and second ends provide respective upper attachment points for attaching the bumper to the vehicle. The bumper further includes a triangular brace having first and second vertices that provide respective lower attachment points for further attaching the bumper to the vehicle, and a third vertex joined with the midpoint of the U-shaped member. A towing receiver is joined with the triangular brace for towing a wide range of payloads. In some examples, the towing receiver receives a tugging hitch adapted for towing (tugging) aircraft, such as small planes and small to medium-sized helicopters.

Advantageously, the improved technique greatly extends the usefulness of firefighting robots and other vehicles to include requirements normally found at customer sites.

Certain embodiments are directed to a bumper for a vehicle. The bumper includes a U-shaped member having first and second ends and a midpoint therebetween, the first and second ends providing respective first and second upper attachment points for attaching the bumper to the vehicle. The bumper further includes a triangular brace having first and second vertices providing respective first and second lower attachment points for attaching the bumper to the vehicle and a third vertex joined with the midpoint of the U-shaped member, and a towing receiver joined with the triangular brace.

In some examples, when viewed from a side of the bumper, the U-shaped member and the triangular brace are joined at a first acute angle and the triangular brace and the towing receiver are joined at a second acute angle.

In some examples, the first acute angle and the second acute angle are equal.

In some examples, the triangular brace is further joined to the U-shaped member at least in part using a set of corner supports.

In some examples, the set of corner supports includes a first corner support including first and second portions disposed at a first corner formed between the U-shaped member and the triangular brace, and a second corner support including third and fourth portions disposed at a second corner formed between the U-shaped member and the triangular brace.

In some examples, each of the first, second, third, and fourth portions is flat and triangular, the first and second portions come together at an angle less than 180 degrees, and the third and fourth portions come together at the same angle.

In some examples, the first and third portions are coplanar with the triangular brace.

In some examples, each of the first, second, third, and fourth portions has an internal, triangular opening, and wherein the triangular opening of each gusset forms a similar triangle with the respective gusset.

In some examples, the triangular brace is divided by a cross member that (i) runs parallel to a first leg of the triangular brace and (ii) connects second and third legs of the triangular brace along their respective lengths. The first leg of the triangular brace connects the first and second vertices.

In some examples, the cross member has a bottom surface that is joined with a top surface of the towing receiver.

In some examples, the bumper further includes a trapezoidal brace that further joins the cross member with the towing receiver. The trapezoidal brace has a long base and a three-sided opening along the long base. The trapezoidal brace joins with the towing receiver on all three sides of the opening and joins with the cross member along the long base on respective sides of the cross member.

In some examples, the bumper further includes a triangular support plate having a first side joined with the cross-member and second and third sides joined respectively with the second and third legs of the triangular brace.

In some examples, the triangular support plate has a trapezoidal aperture formed therein for enabling manual access to the towing receiver.

In some examples, the triangular support plate has first and second drainage cutouts at respective lower corners thereof.

In some examples, the towing receiver has a first end configured to receive a hitch and a second end joined with the first leg of the triangular brace.

In some examples, the bumper further includes first and second trapezoidal support plates disposed between the cross member and the first leg of the triangular support on first and second sides of the towing receiver.

In some examples, each of the first and second trapezoidal support plates has a respective internal rectangular aperture.

In some examples, each of the first and second trapezoidal support plates has respective first and second drainage cutouts at respective lower corners thereof.

In some examples, the bumper further includes first and second tie-down tabs joined with the first and second ends of the U-shaped member.

In some examples, the bumper further includes third and fourth tie-down tabs joined with the first leg of the triangular brace in a spaced-apart manner.

In some examples, the towing receiver includes a pair of transverse opposing holes and a pin configured to pass through the opposing holes for securing a hitch inserted into the tow receiver.

In some examples, the bumper further includes a tugging hitch inserted into the towing receiver, the tugging hitch constructed and arranged for towing aircraft.

In some examples, the tugging hitch includes: a square tube having a proximal end, a distal end, and a pair of transverse holes configured to receive the pin for securing the distal end of the square tube within the towing receiver; a back plate joined with the proximal end of the square tube, the back plate having an upper region and a lower region; a top plate joined with the upper region of the back plate and having an upper hole; a bottom plate joined with the lower region of the back plate and having a lower hole axially aligned with the upper hole; and a removeable tugging pin inserted through both the upper hole and the lower hole.

In some examples, the removeable pin has an upper end having a head and a lower end having a transverse hole therethrough, the head having a handle attached thereto and preventing the removeable pin from falling completely through the upper and lower holes, and the bumper further includes a cotter pin that passes through the transverse hole for securely retaining the removeable pin within the upper and lower holes.

In some examples, the bumper further includes a tether line that connects the handle of the removeable pin to the cotter pin.

Other embodiments are directed to a vehicle that includes a vehicle body and a bumper. The bumper includes a U-shaped member having first and second ends and a midpoint therebetween, the first and second ends providing respective first and second upper attachment points for attaching the bumper to the vehicle. The bumper further includes a triangular brace having first and second vertices providing respective first and second lower attachment points for attaching the bumper to the vehicle and a third vertex joined with the midpoint of the U-shaped member. The bumper still further includes a towing receiver joined with the triangular brace.

In some examples, the bumper is attached to the vehicle body at four attachment points.

In some examples, the vehicle further includes a monitor constructed and arranged to direct water or another firefighting fluid toward a target. The monitor extends beyond the vehicle body, and the bumper extends farther beyond vehicle body than does the monitor. The bumper is thereby constructed and arranged to protect of the monitor from collisions.

In some examples, the bumper is attached to a rear of the vehicle, thereby forming a rear bumper of the vehicle.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is an upper-left front perspective view of an example vehicle with which embodiments of the improved technique can be practiced.

FIG. 2 is an elevated front view of an example bumper in accordance with certain embodiments.

FIG. 3 is an elevated rear view thereof.

FIG. 4 is a top view thereof.

FIG. 5 is a bottom view thereof.

FIG. 6 is an elevated left view thereof. The left and right sides are mirror images.

FIG. 7 is an upper-right rear isometric view thereof.

FIG. 8 is an upper-left front isometric view thereof, with a tugging hitch engaged with a towing receiver of the bumper.

FIG. 9 is an elevated left-side view thereof, with the tugging hitch engaged. The right side is substantially a mirror image of the left side.

FIG. 10 is an upper-right rear isometric view thereof, with the tugging hitch engaged.

FIG. 11 is top view thereof, with the tugging hitch engaged.

### DETAILED DESCRIPTION

Embodiments of the improved technique will now be described. One should appreciate that such embodiments are provided by way of example to illustrate certain features and principles but are not intended to be limiting.

An improved technique provides a vehicle bumper that also serves as a towing and/or tugging receiver. The bumper includes a U-shaped member having first and second ends and a midpoint therebetween. The first and second ends provide respective upper attachment points for attaching the bumper to the vehicle. The bumper further includes a triangular brace having first and second vertices that provide respective lower attachment points for further attaching the bumper to the vehicle, and a third vertex joined with the midpoint of the U-shaped member. A towing receiver is joined with the triangular brace for towing a wide range of payloads.

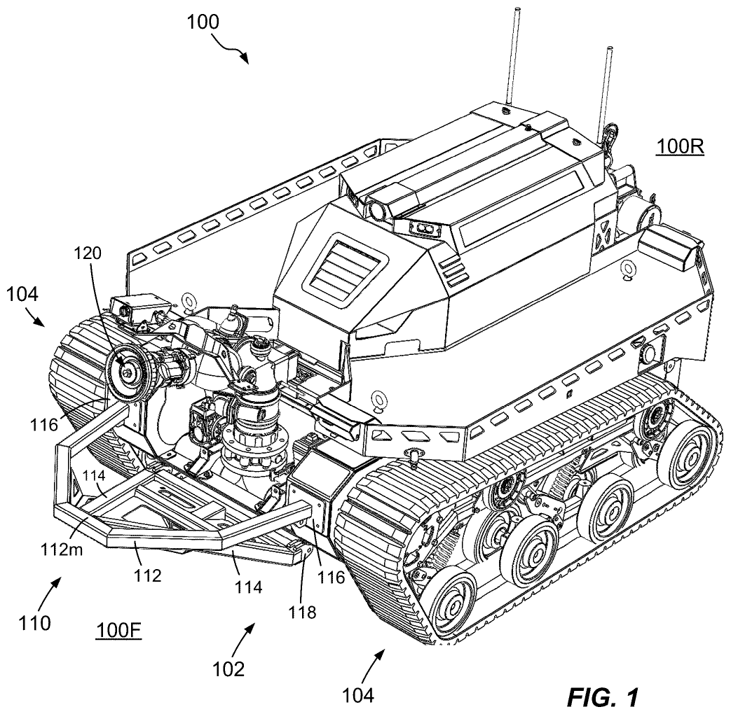

FIG. 1 shows an example vehicle 100 in which embodiments of the improved technique can be practiced. Here, the vehicle 100 includes a vehicle body 102, tracks 104, and a monitor 120. In the depicted example, the vehicle 100 is a firefighting robot, but this is merely an example, as embodiments may be used with other types of vehicles, including vehicles without tracks. The vehicle 100 has a front 100F and a rear 100R.

The body 102 includes, for example, a chassis that houses various equipment for propelling and operating the vehicle, such as batteries and electric motors for use with electrical-drive systems, and/or a fuel tank and liquid-fuel engine for use with internal-combustion drive systems. The body 102 may also house computers, control systems, and the like. The motors and/or engine are configured to drive the tracks 104, e.g., via one or more gearboxes (not shown) within the body 102.

The monitor 120 is constructed and arranged to discharge firefighting fluid, e.g., water, foam, or a combination thereof. For example, a coupling at the rear 100R of the vehicle 100 receives firefighting fluid from a hose connected to a hydrant or firetruck. Piping within the vehicle conveys the fluid to the monitor 120, which can be aimed under remote control in both altitude and azimuth, for emitting the fluid in desired directions.

According to one or more embodiments, the vehicle 100 includes a bumper 110, which also serves as a towing and/or tugging attachment. The bumper 110 includes a U-shaped member 112 joined with a triangular brace 114. In an example, the bumper 110 attaches to the body 102 of the vehicle 100 at four attachment points, including two upper attachment points 116 disposed at first and second ends of the U-shaped bracket 112 and two lower attachment points 118 disposed at first and second vertices of the triangular brace 114. The upper attachment points 116 may be realized, for example, as vertical plates that bolt or otherwise attach to the front 100F of the vehicle 100. The lower attachment points may be realized, for example, as clevises. As an example, a vertically-oriented tab (not visible) may extend from the bottom-front of the vehicle 100 on each side and pass between the two portions of the clevis on the respective side. The tabs and clevises have transverse holes through which clevis pins may be inserted for attaching the bottom of the bumper 110 to the vehicle 100.

The bumper 110 may be attached to the front 110F of the vehicle 100 or to the rear 110R of the vehicle. When mounted to the front 100F of a firefighting robot, the bumper 110 preferably extends farther forward than does the monitor 120, such that the bumper 110, rather than the monitor 120, takes impact from collisions. The bumper 110 thus serves to protect the monitor 120.

The bumper 110 also enables the vehicle 100 to push objects directly. For example, the bumper 110 may be used to push objects across a floor to help clear space, without placing the vehicle 100 (or the monitor 120) at risk.

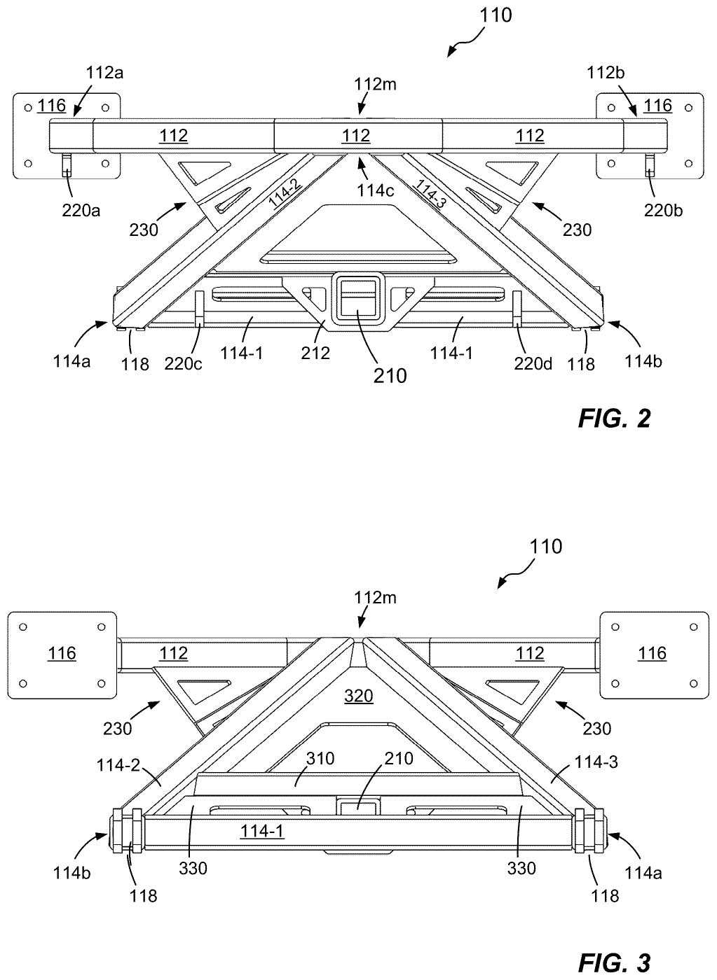

FIGS. 2-11 show additional features of the bumper 110 according to one or more embodiments. FIG. 2 is an elevated front view of the bumper 110, and FIG. 3 is an elevated rear view.

As shown in FIGS. 2 and 3, the U-shaped member 112 extends from a first end 112a to a second end 112b and has a midpoint 112m. In the example shown, the U-shaped member 112 is formed from multiple straight segments that are joined together. As used herein, the term “joined” and its variants means attached together, such as by welding, soldering, or brazing, or by using fasteners, such as screws, bolts, rivets, and the like. The term “joined” also means formed as an integral unit (e.g., by casting or machining).

The triangular brace 114 includes a first leg 114-1, a second leg 114-2, and a third leg 114-3. A first vertex 114a is formed at an intersection of the first leg 114-1 and the second leg 114-2, a second vertex 114b is formed at an intersection of the first leg 114-1 and the third leg 114-3, and a third vertex 114c is formed at an intersection of the second leg 114-2 and the third leg 114-3. The third vertex 114c is joined with the U-shaped member 112 at the midpoint 112m of the U-shaped member 112. In some examples, corner supports 230 are provided for strengthening the attachment of the triangular brace 114 to the U-shaped member 112.

The first and second upper attachment points 116 are provided at the first and second ends 112a and 112b of the U-shaped member 112, respectively. First and second lower attachment points 118 are provided approximately at the first vertex 114a and the second vertex 114b, respectively, of the triangular brace 114, e.g., near opposite ends of the first leg 114-1. In an example, upper tie-downs 220a and 220b are provided at the first and second ends 112a and 112b of the U-shaped structure 112. Also, lower tie-downs 220c and 220d are provided near opposite ends of the first leg 114-1. In an example, the tie-downs 220a-220d are realized as tabs having transverse holes through which chains, cables, ropes, or the like can be passed.

As further shown in FIG. 2, the bumper 110 includes a towing receiver 210 and a trapezoidal brace 212. In an example, the towing receiver 210 has a first end configured to receive a hitch (e.g., a tugging hitch or a towing hitch) and a second end joined with the first leg 114-1 of the triangular brace 114. In an example, the trapezoidal brace 212 has a long base (upper base as shown in FIG. 2) and a three-sided opening for receiving the towing receiver 210. For example, the towing receiver 210 may be welded to the trapezoidal brace 212 on all three sides of the opening, bottom, left, and right. In an example, the towing receiver 210 is a standard 2-inch square (5.1-cm square) towing receiver.

As shown in FIG. 3, the bumper 110 further includes a cross-member 310, which divides an internal area of the triangular brace 114. As shown, the cross-member 310 joins with and extends between the second and third legs 114-2 and 114-3 of the triangular brace 114 and is further joined with the towing receiver 210 and trapezoidal brace 212. For example, a top surface of the towing receiver 210 and a top surface of the trapezoidal brace 212 are joined with a bottom surface of the cross-member 310. FIG. 3 further shows a triangular support plate 320 and first and second trapezoidal support plates 330.

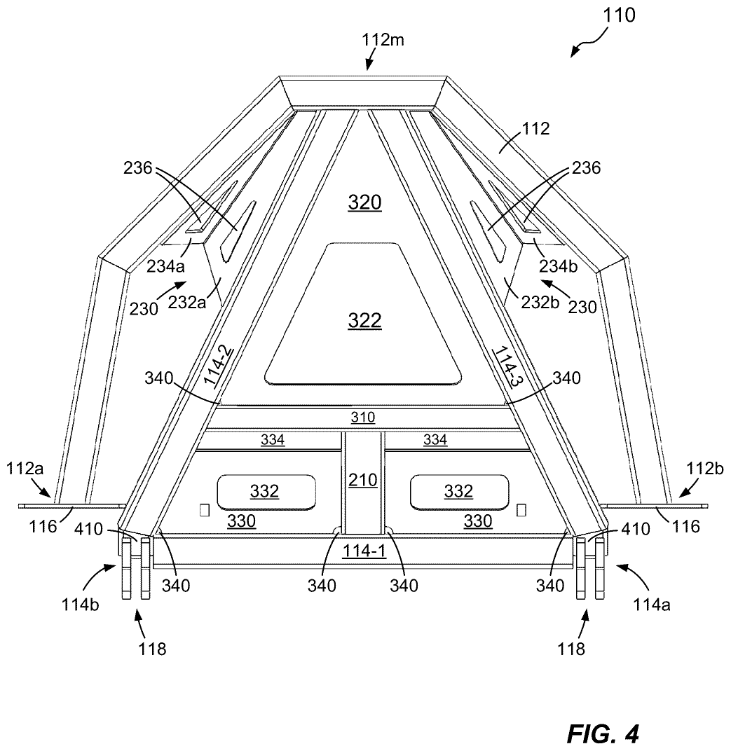

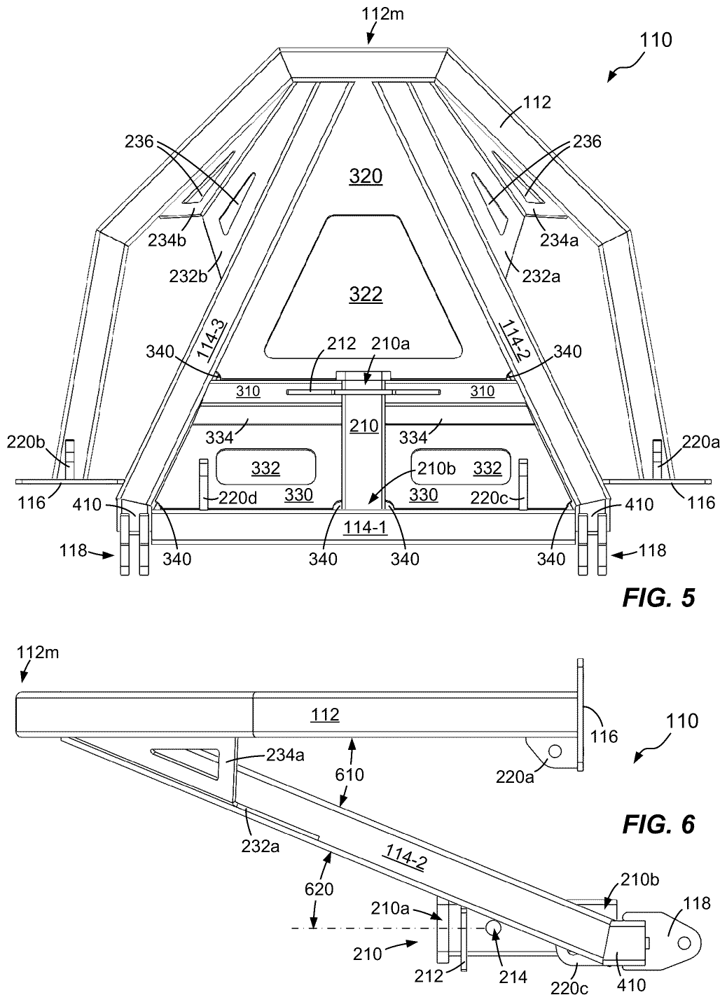

FIGS. 4 and 5 are top-plan and bottom-plan views of the bumper 110, respectively, according to one or more embodiments. As shown, the triangular support plate 320 has a trapezoidal aperture 322, which reduces weight and enables human operators to reach through the aperture 322 for accessing the towing receiver 210. Also, each of the trapezoidal support plates 330 has a rectangular aperture 332, which reduces weight and increases visibility. The trapezoidal support plates 330 include upper regions 334. In an example, the upper regions 334 are angled relative to the trapezoidal support plates 330 such that they are parallel to the plane of the U-shaped bracket 112. For example, the upper regions 334 may be bent portions of the support plates 330, or they may be separate pieces welded to the support plates 330. The triangular support plate 320 and the trapezoidal support plates 330 preferably have lower drainage cutouts 340, which allow any accumulated water to drain, thus water from pooling and reducing the risk of corrosion.

As further shown, a first corner support 230 (shown to the left in FIG. 4) includes a first portion 232a and a second portion 234a. Also, a second corner support 230 (shown to the right of FIG. 4) includes a third portion 232b and a fourth portion 234b. Preferably, the first portion 232a and the third portion 232b are coplanar with the triangular brace 114, and the second portion 232b and the fourth portion 234b form obtuse angles less than 180 degrees with the first and third portions 232a and 232b, respectively. Preferably, each of the portions 232a, 232b, 234a, and 234b has an internal, triangular opening 236, which forms a similar triangle with the portion of which it is part. The openings 236 reduce weight and improve visibility. Each corner support 230 may be formed as a single piece of metal (e.g., sheet metal), which is bent along the boundary between the two portions of that support to form the desired angle. Alternatively, the two portions of each corner support 230 may be provided as two separate pieces that are joined together.

In some examples, the triangular brace 114 further includes corner supports 410, such as a first corner support 410 at the first vertex 114a of the triangular brace 114 and a second corner support 410 at the second vertex 114b of the triangular brace 114. The corner supports 410 strengthen the triangular brace 114 and provide convenient surfaces for joining with the lower attachment points 118 (e.g., clevises).

The parts of the bumper 110 shown in FIGS. 2-5 preferably form a single weldment. For example, a weld is formed along each line where parts are shown to be in direct contact. In an example, the U-shaped member, triangular brace 314, cross member 310, and corner supports 410 are segments of 2-inch square (5.1-cm square) steel tubing. Other types of tubing may be used, however, such as round tubing and/or tubing having different dimensions.

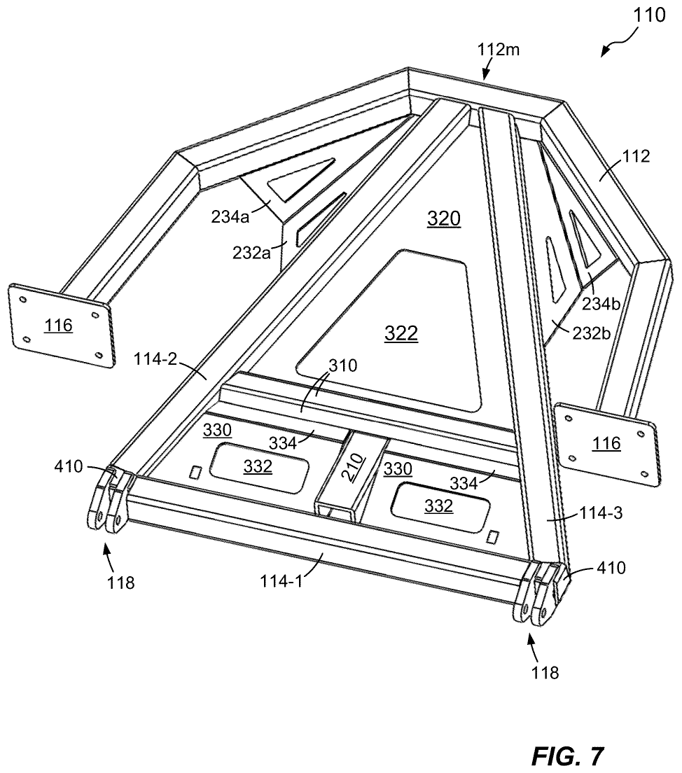

FIG. 6 is an elevated side view of the bumper 110 according to one or more embodiments. Preferably, the bumper 110 is symmetrical when viewed from both sides. Here, it is seen that the U-shaped bracket 112 joins with the triangular brace 114 at an acute angle 610. Also, the triangular brace 114 joins with the towing receiver 210 at an acute angle 620. As the towing receiver 210 is parallel to the U-shaped bracket 112 from the illustrated perspective, the angles 610 and 620 are alternate interior angles and thus are equal.

FIG. 6 also shows additional details of the towing receiver 210. As shown, the towing receiver 210 has a first end 210a and a second end 210b. The towing receiver 210 also has a pair of aligned transverse holes 214 (one facing out of the page and one facing into the page). In an example, the holes 214 are positioned to align with transverse holes of a tugging hitch when the tugging hitch is inserted into the towing receiver 210, such that a pin can be passed through the holes 214 and the holes in the tugging hitch to secure the tugging hitch in place. Additional aspects of certain above-described features may be seen in the isometric view of FIG. 7.

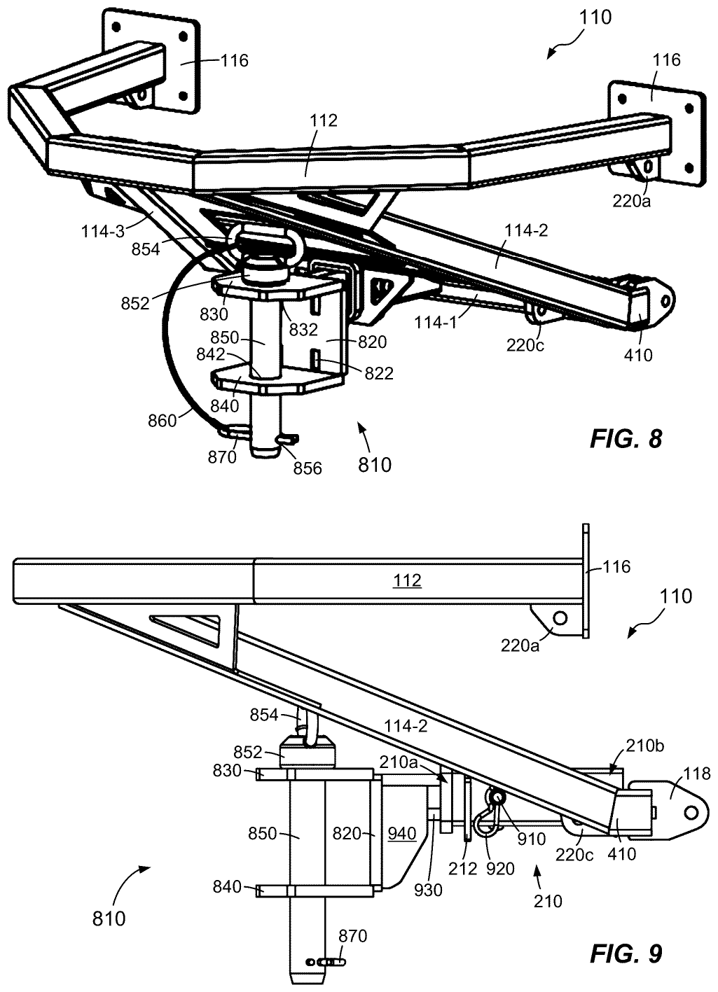

FIG. 8 is an isometric view of the bumper 110 with a tugging hitch 810 inserted into and secured within the towing receiver 210 according to one or more embodiments.

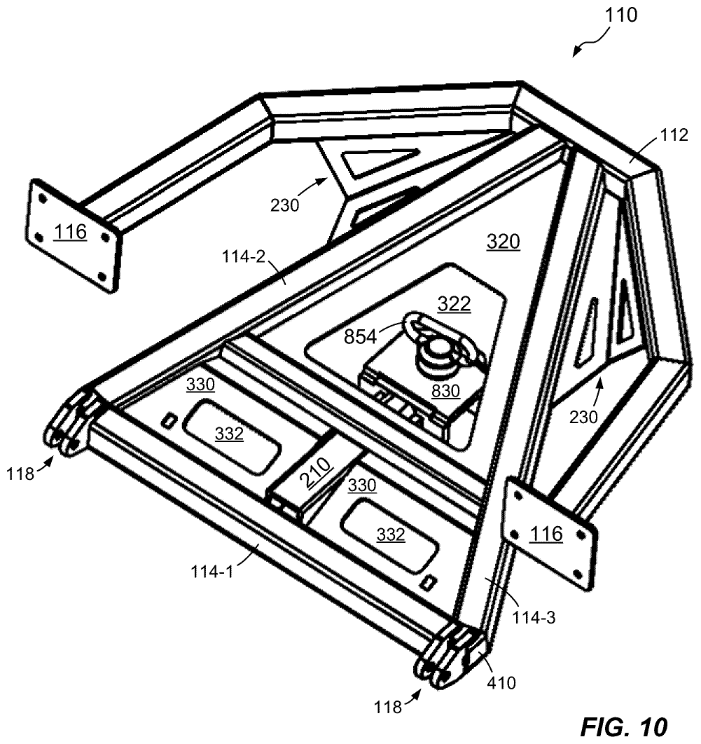

FIG. 9 shows a side view of the same arrangement. In an example, the tugging hitch 810 is arranged for tugging small airplanes and small to medium-sized helicopters. In a common arrangement, a tow bar (not shown) is attached between an aircraft and a tugging hitch, such as the illustrated tugging hitch 810. At the vehicle end, the tow bar terminates in a horizontal eyelet having a central hole through which a tugging pin can be passed. The vehicle can then tow the aircraft via the tugging hitch and the tow bar.

As shown in FIGS. 8 and 9, the tugging hitch 810 includes a back plate 820, a top plate 830, and a bottom plate 840, which may be formed as three separate pieces joined together or as a single piece bent into a C-shape, for example. The top plate 830 has an upper hole 832, and the bottom plate 840 has a lower hole 842. The two holes 832 and 842 are aligned for receiving a removable tugging pin 850, such as a 1.5-inch (3.8-cm) pin. The tugging pin 850 has a head 852 and a handle 854 attached to the head 852. The handle 854 is arranged to facilitate manual insertion and withdrawal of the tugging pin 850 from the tugging hitch 810, e.g., by a human operator reaching through the trapezoidal aperture 322 and grasping the handle 854. The tugging pin 850 has a transverse hole 856 arranged for receiving a cotter pin 870. In some examples, a tether line 860, such as a metal, plastic, or fabric cable, attaches the cotter pin 870 to the handle 854 to ensure that the cotter pin 870 is always present.

The tugging hitch 810 further includes a square tube 930 and a pair of rear supports 940 (FIG. 9), e.g., one rear support on each side of the square tube 930. The rear supports 940 are joined with the back plate 820. For example, the back plate 820 has slotted holes 822 for receiving tabs that extend from the rear supports 940 for forming a secure weldment. The square tube 930 has a proximal end joined with the back plate 820 and with the rear supports 940. The square tube 930 also has a distal end removably disposed with the towing receiver 210. The distal end of the square tube 930 has a pair of transverse holes (not visible) which align with the transverse holes 214 in the towing receiver (FIG. 2) when the tugging hitch 810 is inserted into the towing receiver 210. A towing hitch pin 910, such as a ⅝-inch (1.6-cm) pin, may be inserted through the aligned holes for securing the tugging hitch 810 within the towing receiver 210. A cotter pin 920 may be provided for retaining the towing hitch pin 910 within the holes.

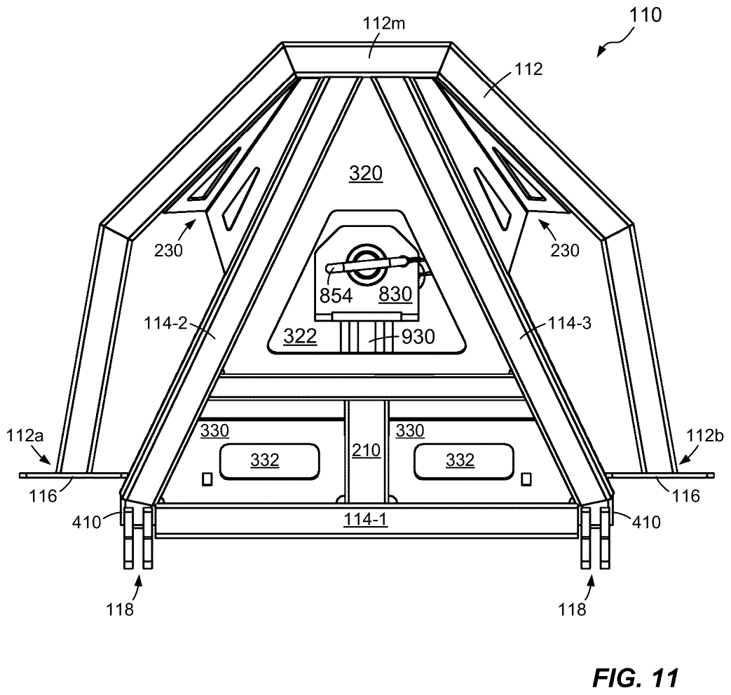

FIGS. 10 and 11 respectively show isometric and top-plan views of the bumper 110 with the tugging hitch 810 inserted into the towing receiver 210, according to one or more embodiments. It is plainly seen that the trapezoidal aperture 322 allows convenient access to the tugging pin 850 via the handle 854.

An improved technique has been described for extending the usefulness of a vehicle 100 for towing and/or tugging, while also protecting the front 100F of the vehicle 100 from damage, particularly a monitor 120 in cases where the vehicle 100 takes the form of a firefighting robot. The technique may be embodied as a bumper 110 having a towing receiver 210 arranged to receive a tugging hitch 810. The bumper 110 may be used with or without the tugging hitch, and multiple bumpers may be provided, such as one bumper 110 at the front 100F of the vehicle 100 and another bumper 110 at the rear 100R of the vehicle 100. Although the bumper 110 has been described for use with a tugging receiver 810, which is well-suited for moving airplanes and helicopters, the bumper 110 may also be used with a more common towing hitch, such as a standard ball and pintle, for pulling trailers and other equipment.

Use of the bumper 110 with a firefighting robot brings particular advantages. As the operator can be remote from the vehicle 100, careful and precise movements can be achieved in tight, narrow, precarious environments. For example, the operator can be positioned near an obstruction and can ensure that the item being moved does not collide with the obstruction or with other objects nearby.

Having described certain embodiments, numerous alternative embodiments or variations can be made. Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

Table of Reference Numerals

| Reference | |
|---|---|
| Numeral | Description |
| 100 | Vehicle, such as robotic firefighting vehicle |
| 100F | Front of vehicle |
| 100R | Rear of vehicle |
| 102 | Vehicle body |
| 110 | Bumper |
| 112 | U-shaped member, e.g., composed of |
| | square steel tubing; other cross- |
| | sectional shapes, such as round, are also feasible. |
| 112a, 112b | First and second ends of U-shaped member |
| 112m | Midpoint of U-shaped member |
| 114 | Triangular brace |
| 114a, 114b, | First, second, and third vertices, |
| 114c | respectively, of triangular brace |
| 114-1, 114-2, | First, second, and third legs, respectively, |
| 114-3 | or triangular brace |
| 116 | Upper attachment points (x2) of bumper to vehicle |
| 118 | Lower attachment points (x2) of bumper |
| | to vehicle, such as clevis |
| 120 | Monitor, for directing water or other |
| | firefighting fluid toward a target, |
| | such as a fire. May be aimed in |
| | altitude (up/down) and azimuth |
| | (left/right) |
| 210 | Towing receiver |
| 210a, 210b | First and second ends, respectively, of towing receiver |
| 212 | Trapezoidal brace, for strengthening |
| | attachment of towing hitch to |
| | cross member; has 3-sided square |
| | aperture (cutout) for receiving |
| | towing receiver 210 and attaching |
| | it bottom of cross member 310. |
| 214 | Transverse holes in towing receiver, |
| | e.g., for receiving pin, such as |
| | 5/8″ (1.6-cm) pin, for securing hitch. |
| 220a, 220b, | First, second, third, and fourth tie downs, |
| 220c, 220d | respectively. |
| 230 | Corner supports, e.g., for strengthening |
| | attachment of triangular brace |
| | to U-shaped member |
| 232a, 232b | First and third portions of a corner |
| | support, respectively, e.g., coplanar |
| | with triangular brace 114. |
| 234a, 234b | Second and fourth portions of a corner |
| | support, respectively, e.g., |
| | form obtuse angle less than 180 |
| | degrees with first and third gussets, |
| | respectively. |
| 236 | Internal triangular opening (x4) in |
| | gusset, e.g., forming similar |
| | triangle with portion of which it is |
| | a part. Reduces weight and |
| | improves visibility. |
| 310 | Cross member |
| 320 | Triangular support plate |
| 322 | Trapezoidal aperture in triangular |
| | support plate, e.g., enables manual |
| | access from above to towing receiver. |
| 330 | Trapezoidal support plate (x2) |
| 332 | Rectangular aperture (x2) of |
| | trapezoidal support plate, e.g., for |
| | reducing weight and improving visibility. |
| 334 | Top region of trapezoidal support plate |
| | (e.g., angled relative to trapezoidal |
| | support plate and parallel with ground) |
| 340 | Lower drainage cutouts (x6), e.g., for |
| | preventing collection of water. |
| 410 | Corner supports, e.g., square tubing |
| | for strengthening rear corners of |
| | triangular brace and providing anchor |
| | points for lower attachment |
| | points. |
| 610 | Angle of U-shaped bracket to triangular brace |
| 620 | Angle of triangular brace to towing |
| | receiver. For example, U-shaped |
| | member and towing receiver are parallel |
| | and angles 610 and 620 are |
| | alternate interior angles, which are equal. |
| 810 | Tugging hitch |
| 820 | Back plate of tugging hitch |
| 822 | Holes in back plate, e.g., for |
| | receiving tabs (not shown) in rear |
| | supports and strengthening attachment |
| 830 | Top plate of tugging hitch |
| 832 | Upper hole in top plate; aligned with |
| | lower hole in bottom plate for |
| | receiving tugging pin |
| 840 | Bottom plate of tugging hitch |
| 842 | Lower hole in bottom plate; aligned |
| | with upper hole in top plate for |
| | receiving tugging pin |
| 850 | Removeable tugging pin (e.g., 1.5-inch/3.8-cm pin) |
| 852 | Head of tugging pin |
| 854 | Handle of tugging pin, can be |
| | inserted and removed by hand via |
| | trapezoidal aperture 322. |
| 856 | Transverse hole through tugging pin, |
| | e.g., for receiving cotter pin |
| 860 | Tether, e.g., for securing cotter |
| | pin 870 to handle 854 |
| 870 | Cotter pin |
| 910 | Towing hitch pin, e.g., 5/8″ (1.6-cm) |
| | pin for securing tugging hitch to |
| | towing receiver |
| 920 | Cotter pin, e.g., for holding tugging |
| | hitch pin within holes 214 |
| 930 | Square tube, e.g., having a proximal |
| | end (joined with back plate 820 |
| | and rear supports 940), a distal end |
| | (within the towing receiver), and a |
| | pair of transverse holes (not visible) |
| | configured to receive the pin 910 |
| | for securing the distal end of the |
| | square tube within the towing |
| | receiver. |
| 940 | Rear supports, e.g., one support on |
| | each side of square tube 930; |
| | includes tabs that insert into holes |
| | 822 in back plate for forming |
| | secure weldment |

What is claimed is:

1. A bumper for a vehicle, comprising:
a U-shaped member having first and second ends and a midpoint therebetween, the first and second ends providing respective first and second upper attachment points for attaching the bumper to the vehicle;
a triangular brace having first and second vertices providing respective first and second lower attachment points for attaching the bumper to the vehicle and a third vertex joined with the midpoint of the U-shaped member; and
a towing receiver joined with the triangular brace.

2. The bumper of claim 1 wherein, when viewed from a side of the bumper, the U-shaped member and the triangular brace are joined at a first acute angle and the triangular brace and the towing receiver are joined at a second acute angle.

3. The bumper of claim 2 wherein the first acute angle and the second acute angle are equal.

4. The bumper of claim 2, wherein the triangular brace is further joined to the U-shaped member at least in part using a set of corner supports.

5. The bumper of claim 4, wherein the set of corner supports includes:
a first corner support including first and second portions disposed at a first corner formed between the U-shaped member and the triangular brace; and
a second corner support including third and fourth portions disposed at a second corner formed between the U-shaped member and the triangular brace.

6. The bumper of claim 5, wherein each of the first, second, third, and fourth portions is flat and triangular, wherein the first and second portions come together at an angle less than 180 degrees, and wherein the third and fourth portions come together at the same angle.

7. The bumper of claim 6, wherein the first and third portions are coplanar with the triangular brace.

8. The bumper of claim 6, wherein each of the first, second, third, and fourth portions has an internal, triangular opening, and wherein the triangular opening of each gusset forms a similar triangle with the respective gusset.

9. The bumper of claim 2, wherein the triangular brace is divided by a cross member that (i) runs parallel to a first leg of the triangular brace and (ii) connects second and third legs of the triangular brace along their respective lengths, the first leg of the triangular brace connecting the first and second vertices.

10. The bumper of claim 9, wherein the cross member has a bottom surface that is joined with a top surface of the towing receiver.

11. The bumper of claim 10, further comprising a trapezoidal brace that further joins the cross member with the towing receiver, the trapezoidal brace having a long base and a three-sided opening along the long base, the trapezoidal brace joining with the towing receiver on all three sides of the opening and joining with the cross member along the long base on respective sides of the cross member.

12. The bumper of claim 9, further comprising a triangular support plate having a first side joined with the cross-member and second and third sides joined respectively with the second and third legs of the triangular brace.

13. The bumper of claim 12, wherein the triangular support plate has a trapezoidal aperture formed therein for enabling manual access to the towing receiver.

14. The bumper of claim 9, wherein the towing receiver has a first end configured to receive a hitch and a second end joined with the first leg of the triangular brace.

15. The bumper of claim 14, further comprising first and second trapezoidal support plates disposed between the cross member and the first leg of the triangular support on first and second sides of the towing receiver.

16. The bumper of claim 2, wherein the towing receiver includes a pair of transverse opposing holes and a pin configured to pass through the opposing holes for securing a hitch inserted into the tow receiver.

17. The bumper of claim 16, further comprising a tugging hitch inserted into the towing receiver, the tugging hitch constructed and arranged for towing aircraft.

18. The bumper of claim 17, wherein the tugging hitch includes:
a square tube having a proximal end, a distal end, and a pair of transverse holes configured to receive the pin for securing the distal end of the square tube within the towing receiver;
a back plate joined with the proximal end of the square tube, the back plate having an upper region and a lower region;
a top plate joined with the upper region of the back plate and having an upper hole;
a bottom plate joined with the lower region of the back plate and having a lower hole axially aligned with the upper hole; and
a removeable tugging pin inserted through both the upper hole and the lower hole.

19. A vehicle, comprising a vehicle body and a bumper attached to the vehicle body, the bumper including:
a U-shaped member having first and second ends and a midpoint therebetween, the first and second ends providing respective first and second upper attachment points for attaching the bumper to the vehicle;
a triangular brace having first and second vertices providing respective first and second lower attachment points for attaching the bumper to the vehicle and a third vertex joined with the midpoint of the U-shaped member; and
a towing receiver joined with the triangular brace.

20. The vehicle of claim 19, further comprising a monitor constructed and arranged to direct water or another firefighting fluid toward a target, the monitor extending beyond the vehicle body, wherein the bumper extends farther beyond vehicle body than does the monitor, the bumper thereby constructed and arranged to protect of the monitor from collisions.
